(19) United States
(12) Patent Application Publication
(10) Pub. No.: US 2022/0297681 A1
(43) Pub. Date: Sep. 22, 2022

(54) VEHICLE CONTROL SYSTEM

(71) Applicant: HONDA MOTOR CO., LTD., Tokyo (JP)

(72) Inventors: Takuya YOSHINAGA, Tokyo (JP); Hisanori YANAGIDA, Tokyo (JP); Hiroyuki MIDORIKAWA, Tokyo (JP); Zhenxiong HUANG, Tokyo (JP)

(21) Appl. No.: 17/681,723

(22) Filed: Feb. 26, 2022

(30) Foreign Application Priority Data
Mar. 22, 2021 (JP) 2021-046807

(51) Int. Cl. B60W 30/08; B60W 50/12; B60W 50/08; B60W 30/18

(52) U.S. Cl. CPC B60W 30/08; B60W 50/12; B60W 50/087; B60W 30/18109; B60W 2030/082

(57) ABSTRACT

A vehicle control system prevents an acceleration opposing a driver's intention even when the driver mistakenly depresses an accelerator pedal on a vehicle collision. When a collision of the vehicle is detected by an airbag system, a controller performs a brake assist control to increase a braking force of the vehicle and also performs a driving force reduction assist control to reduce a vehicle driving force to a lower value than normal based on an operation amount of the accelerator pedal. The driving force reduction assist control is continued if the accelerator pedal operation amount detected by the accelerator pedal becomes equal to or above a predetermined threshold during a time before the collision to a predetermined time after the collision and keeps equal to or above the threshold even after the brake assist control is released after the vehicle comes to a stop.

### CROSS REFERENCE TO RELATED APPLICATION

The present invention relates to and asserts priority from Japanese patent application No. 2021-046807 filed on Mar. 22, 2021, and incorporates entirety of contents and subject matter of the above application herein by reference.

### TECHNICAL FIELD

The present invention relates to a vehicle control system.

### BACKGROUND ART

Patent Literature 1 (PTL 1) describes an automatic braking control and a driving force suppression control as safety features for a case that a vehicle detects a collision.

### CITATION LIST

### Patent Literature

[PTL 1] Japan patent No. JP6216290

### SUMMARY OF INVENTION

### Technical Problem

However, according to an art of PTL 1, if a driver accidentally depresses an accelerator pedal and continues the depression at a time of a vehicle collision even though he has intended to immediately depress a brake pedal, a driving force limitation is activated at the same time as the automatic braking is activated due to reasons such as the automatic braking being activated and the vehicle coming to a stop. This may cause the driving force limitation to be released at the same time as the automatic braking is released. This may cause the vehicle to accelerate contrary to the driver's intention.

On the other hand, if both the automatic braking and the driving force limitation remain activated, the vehicle cannot accelerate and cannot move to an appropriate location.

### Technical Problem

Therefore, it is an object of the present invention to provide a vehicle control system that is able to prevent an acceleration contradicting a driver's intention, even when the driver mistakenly depresses the accelerator pedal at a time of a vehicle collision.

### Solution to Problem

The invention provides a vehicle control system comprising a brake pedal depression amount sensor that detects a depression amount of the brake pedal, an accelerator pedal operation amount sensor that detects an operation amount of an accelerator pedal, a collision detection sensor that detects a collision of a vehicle, and a controller, wherein the controller, when a collision of the vehicle is detected by the collision detection sensor, performs a brake assist control to increase a braking force of the vehicle and simultaneously performs a driving force reduction assist control to reduce a vehicle driving force generated on a basis of the operation amount of the accelerator pedal to a lower value than normal; and continues the driving force reduction assist control if the operation amount of the accelerator pedal detected by the accelerator pedal operation amount sensor becomes equal to or above a predetermined threshold until a predetermined time after the collision is detected by the collision detection sensor and keeps equal to or above the threshold even after the brake assist control is deactivated after the vehicle comes to a stop.

### BRIEF DESCRIPTION OF DRAWINGS

FIG. 1 is a block diagram of an electrical connection in a vehicle control system according to an embodiment of the present invention.

FIG. 2 is a timing chart illustrating a specific example of processing performed by the vehicle control system according to the embodiment of the present invention.

### DESCRIPTION OF EMBODIMENTS

An embodiment of the present invention is described below.

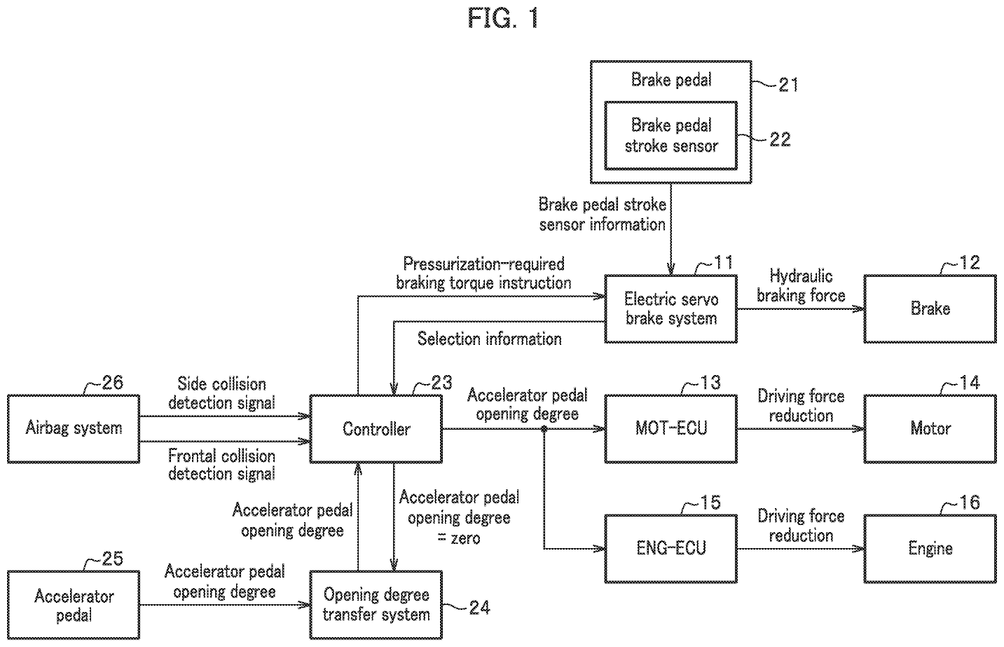

FIG. 1 is a block diagram showing an electrical connection of a vehicle control system that is an embodiment of the present invention. The vehicle control system 1 is provided with an electric servo brake system 11, which generates a hydraulic braking force used in vehicle's brakes 12. MOT-ECU (Motor Electronic Control Unit) 13 directs to a motor 14 a driving force to be generated by the motor 14 that is a driving source of the vehicle. ENG-ECU (Engine Electronic Control Unit) 15 directs to an engine 16 a driving force to be generated by the engine 16 that is a driving source of the vehicle. As shown above, this is an example for a hybrid vehicle equipped with both the motor 14 and the engine 16 as the driving source, but the vehicle may also be an electric vehicle (including a fuel cell vehicle) or a gasoline vehicle respectively with only either the motor 14 or the engine 16 as the driving source.

The brake pedal 21 is equipped with a brake pedal stroke sensor 22 (brake pedal depression amount sensor) that detects a depression amount of the brake pedal, and information on the brake pedal depression amount is transmitted to the electric servo brake system 11 as brake pedal stroke sensor information. Information transmission in the vehicle may be done by CAN (Control Area Network) or devices to be communicated may be directly connected to each other. The depression amount of the brake pedal is not limited to be detected on the basis of the brake pedal stroke, but may also be detected on the basis of a brake depressing pressure or brake depressing force.

The controller 23 controls a braking torque generated by the brake 12 and a driving torque generated by the motor 14 and engine 16. The controller 23 performs control such as instructing the electric servo brake system 11, MOT-ECU 13, and ENG-ECU 15 on the braking torque to be generated by the brake 12 and the driving torque to be generated by the motor 14 and the engine 16 (pressurization-required braking torque, or request-driven torque).

An accelerator pedal 25 detects its own operation amount using an accelerator pedal operation amount sensor and transmits information of an accelerator pedal opening degree via an opening degree transfer system 24 to the controller 23.

The airbag system 26 is an airbag triggered when a certain vehicle collision occurs. When the vehicle causes a collision and it is detected by sensors of the airbag system 26, depending on the situation of the collision, a side collision detection signal or a frontal collision detection signal is sent to the controller 23. Here, it is supposed that the collision of the vehicle would be detected by the airbag system 26, however sensors detecting a collision may be equipped at a separate place in the vehicle.

When the controller 23 receives the side or frontal collision detection signal from the airbag system 26, the controller 23 sends to an electric servo brake system 11 an instruction of generating a pressurization-required braking torque, which instruction requests automatic braking (post-collision automatic braking). The electric servo brake system 11 also receives the brake pedal stroke sensor information from the brake pedal stroke sensor 22. The electric servo brake system 11 compares the pressurization amount of the automatic braking requested by the controller 23 with the pressurization amount of the brake indicated by the brake pedal stroke sensor information; performs a brake assist control to drive the brake 12 with the larger pressure amount; and also informs the controller 23 which one is selected from the pressurization amount of the automatic braking and the pressurization amount of the brake indicated by the brake pedal stroke sensor information (informing).

In this case, the controller 23 also sends an instruction of generating the driving torque respectively to the MOT-ECU 13 and ENG-ECU 15 to perform a driving force reduction assist control to lower the driving force of the vehicle than a normal time. The controller 23 performs this driving force reduction assist control by instructing the opening degree transfer system 24 to transmit thereto an accelerator pedal opening degree of zero and causing the opening degree transfer system 24 to return to the controller 23 the accelerator pedal opening degree of zero. Note that the accelerator pedal opening degree specified to be transmitted from the opening degree transfer system 24 to the controller 23 may be set to a value in a low opening range that is able to perform deceleration.

Alternatively, it may be also allowed for the controller 23 to set the required driving force specified to the MOT-ECU 13 and ENG-ECU 15 to zero and to make the driving force of the vehicle to zero. Here again, although the required driving force specified by the controller 23 to the MOT-ECU 13 and ENG-ECU 15 may be set to zero, but they may be also set to a value in a range where deceleration can be performed.

The operation amount of the accelerator pedal 25 is detected within a predetermined time period after a collision detection made by the airbag system 26. There is a case in which the detected operation amount of the accelerator pedal 25 exceeds a predetermined threshold. This might be a case that a driver is hurried to accidentally press the accelerator pedal 25 in spite of an attempt to press the brake pedal 21.

Even in this case, the controller 23 deactivates the above-mentioned brake assist control after the vehicle stops.

However, even after the vehicle comes to a stop, the controller 23 continues the aforementioned driving force reduction assist control if the operation amount of the accelerator pedal 25 is kept above the aforementioned threshold (if the accelerator pedal 25 continues to be depressed).

The above control is performed in the same way when the accelerator pedal 25 is depressed even before the vehicle collision.

And thereafter, when the controller 23 detects that the accelerator pedal 25 is released by the driver, the controller 23 deactivates the aforementioned driving force reduction assist control.

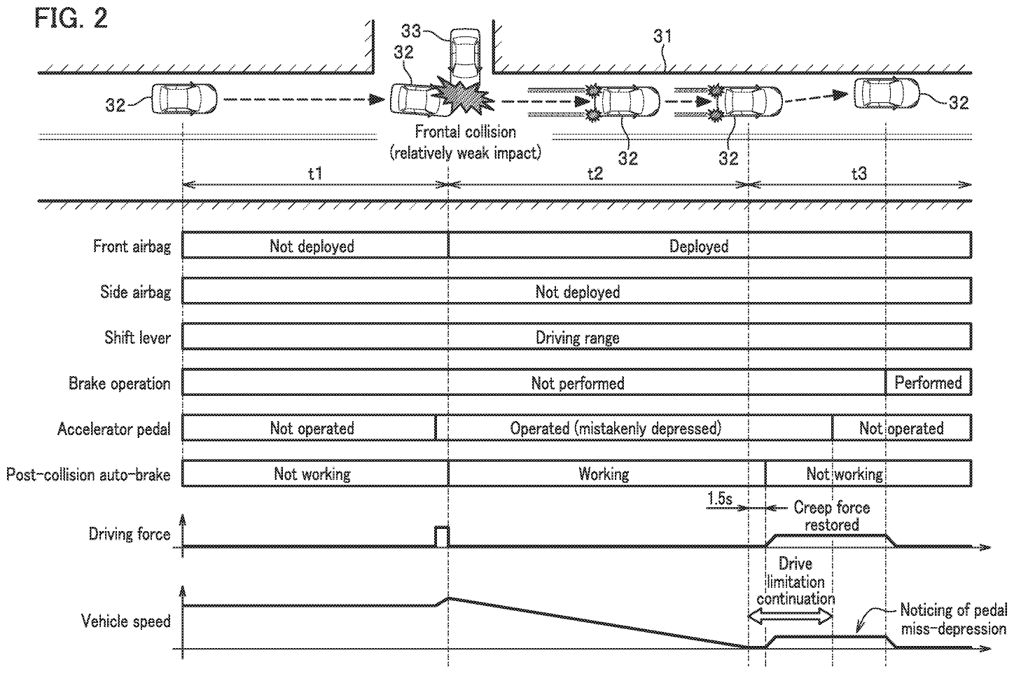

Next description is a specific example of a processing performed by the vehicle control system 1. FIG. 2 is a timing chart illustrating a specific example of the processing performed by the vehicle control system 1. The upper row shows a vehicles 32 traveling on the roadway 31 at positions where the vehicles 32 is present at times (time periods) t1, t2, and t3.

The bottom row shows a timing chart of each part of the vehicle 32 at each time point (each time period) corresponding to the time in the upper row. In other words, there are descriptions from the top to the bottom of FIG. 2, “front airbag” and “side airbag”: deployed or not deployed; “shift lever” range; “brake operation” by a driver: performed or not; accelerator pedal: operated or not; “automatic braking (post-collision automatic braking)” mentioned above: activated or deactivated; “driving force” of the vehicle (the vertical axis shows the magnitude of the driving force); “vehicle speed”’ (the vertical axis shows the magnitude of the vehicle speed).

First, during an early time of t1, the vehicle 32 is normally running. Therefore, the “front airbag” and “side airbag” are not deployed; the “shift lever” is in a driving range; the “brake operation” is not performed; the “accelerator pedal” is not operated; the “post-collision automatic braking” is not activated; the “driving force” is not generated at first; the vehicle speed is constant at a predetermined speed. However, at an end of time t1, the “accelerator pedal” changes to be “operated” when the accelerator pedal 25 is operated, which generates the “driving force”; and thereby the vehicle speed slightly increases. This means that the driver tries to depress the brake pedal 21 just before a collision (at the end of time t1) but mistakenly depresses the accelerator pedal 25, which leads to the collision.

At the beginning of time t2, the vehicle 32 causes a relatively weak frontal collision (offset collision) with another vehicle 33 at a T-junction. This causes the “front airbag” to be deployed, and the airbag system 26 shown in FIG. 1 outputs a frontal collision detection signal to the controller 23. This results in performing the above-mentioned brake assist control and the driving force reduction assist control by the controller 23 informed of a fact of the collision of the vehicle 32. This also causes the “post-collision automatic braking” to start working to reduce the “driving force” to zero, as shown in FIG. 2. In this case, the brake pedal stroke sensor information is inputted to the electric servo brake system 11 shown in FIG. 1 with zero stroke (the brake pedal 21 is not depressed). Therefore, a brake pressure of the post-collision automatic braking is higher than that of the brake pedal stroke sensor information, and thus, the electric servo brake system 11 selects the brake pressure of the post-collision automatic braking to generate the brake pressure.

Although the driver should press the brake 12, he/she continues to press the accelerator pedal 25 due to being in a hurry with the collision of the vehicle 32 or due to an impact of the collision. However, the “post-collision automatic braking” continues to operate and the “driving force” continues to be zero. At the end of time t2, the vehicle comes to a stop (“vehicle speed” is zero). After the collision, when a predetermined time period elapses with the “vehicle speed” of zero (in this example, time t2+1.5 second), the brake assist control is stopped and the post-collision automatic braking is deactivated. However, the controller 23 continues the driving force reduction assist control during a “drive limitation continuation” period after an elapse of time period t2. Although the accelerator pedal 25 continues to be depressed, a creep force only is recovered with a start of the deactivation of the “post-collision automatic braking”. This is because, as described with reference to FIG. 1, the driving force reduction assist control causes the controller 23 to continue instructing the opening degree transfer system 24 to transmit that the opening degree of the accelerator pedal is zero and this causes the opening degree transfer system 24 to continue notifying the controller 23 that the opening degree of the accelerator pedal 25 is zero. Therefore, as shown in FIG. 2, only the creep force is restored at the timing when the “post-collision automatic braking” stops working. In other words, in the situation shown in FIG. 2, even if the accelerator pedal 25 continues to be depressed, no abrupt acceleration or the like occurs and the vehicle 32 moves forward at a slight speed by the creep force.

In this way, because the creep force is generated even when the driver thinks he is depressing the brake pedal 21, this makes it easier for the driver to notice his or her own driving wrong operation (because the vehicle 32 moves forward at a slight speed in the example of FIG. 2). Then, the driver realizes that he/she is continuing to press the accelerator pedal 25 and at last deactivates the accelerator pedal 25 in a middle of time t3. This results in deactivating of the driving force reduction assist control. Consequently, the creep force is still generated during the above-mentioned period (after the “drive limitation continuation” period elapses, the driving force reduction assist control is stopped and thereby a normal acceleration also becomes available); the creep force moves the vehicle to an appropriate place; and the vehicle is stopped by the “brake operation” caused to be “performed.”

According to the embodiment described above, if the accelerator pedal 25 is “operated” continuously from a time within a predetermined time period after a vehicle collision detection or from a time before the vehicle collision detection until the end of the post-collision automatic braking, it is highly possible that the accelerator pedal 25 is mistakenly pressed. Therefore, unintended acceleration by the driver is able to be suppressed by continuing the driving force reduction assist control of the vehicle even after the post-collision automatic braking is terminated.

After that, releasing the accelerator pedal 25 allows this driving force reduction assist control to be deactivated. By deactivating the driving force reduction assist control when the accelerator pedal 25 is released, the next acceleration is made available at a time when the accelerator pedal is depressed (i.e., when the driver intends to accelerate), which allows the vehicle to behave according to the driver's intention.

### REFERENCE SIGNS LIST

1: Vehicle control system
21: Brake pedal
22: Brake pedal stroke sensor (brake pedal depression amount sensor)
23: Controller
25: Accelerator pedal (accelerator pedal operation amount sensor)
26: Airbag system (collision detection sensor)
32: Vehicle

1. A vehicle control system comprising:
a brake pedal depression amount sensor that detects a depression amount of a brake pedal;
an accelerator pedal operation amount sensor that detects an operation amount of an accelerator pedal;
a collision detection sensor that detects a collision of a vehicle; and
a controller,
wherein
the controller is configured to:
perform a brake assist control to increase a braking force of the vehicle and also performs a driving force reduction assist control to reduce a vehicle driving force generated on a basis of the operation amount of the accelerator pedal to a lower value than a normal time when a collision of the vehicle is detected by the collision detection sensor; and
continue the driving force reduction assist control if the accelerator pedal operation amount detected by the accelerator pedal operation amount sensor becomes equal to or above a predetermined threshold until a predetermined time after the collision is detected by the collision detection sensor and keeps equal to or above the predetermined threshold even after the brake assist control is deactivated after the vehicle comes to a stop.

2. A vehicle control system comprising:
a brake pedal depression amount sensor that detects a depression amount of a brake pedal;
an accelerator pedal operation amount sensor that detects an operation amount of an accelerator pedal;
a collision detection sensor that detects a collision of a vehicle; and
a controller,
wherein
the controller is configured to:
perform a brake assist control to increase a braking force of the vehicle and also performs a driving force reduction assist control to reduce a vehicle driving force generated on a basis of the operation amount of the accelerator pedal to a lower value than a normal time when a collision of the vehicle is detected by the collision detection sensor; and
continue the driving force reduction assist control if the operation amount of the accelerator pedal detected by the accelerator pedal operation amount sensor keeps equal to or above a predetermined threshold from a time of or before the collision is detected by the collision detection sensor and keeps equal to or above the threshold even after the brake assist control is deactivated after the vehicle comes to a stop.

3. The vehicle control system according to claim 1,
wherein
the controller is configured to deactivate the driving force reduction assist control when the accelerator pedal operation amount sensor detects that the accelerator pedal is released.

4. The vehicle control system according to claim 2,
wherein
the controller is configured to deactivate the driving force reduction assist control when the accelerator pedal operation amount sensor detects that the accelerator pedal is released.
